(19) United States
(12) Patent Application Publication
(10) Pub. No.: US 2014/0129623 A1
(43) Pub. Date: May 8, 2014

(54) SYSTEMS AND METHODS FOR PROTECTING DATA FOR SERVER-BASED COMPUTATIONS

(71) Applicant: Vikram Jandhyala, Seattle, WA (US)

(72) Inventor: Vikram Jandhyala, Seattle, WA (US)

(73) Assignee: University of Washington Through its Center for Commercialization, Seattle, WA (US)

(21) Appl. No.: 14/113,197

(22) PCT Filed: Apr. 23, 2012
(86) PCT No.: PCT/US2012/034711

§ 371 Date: Dec. 18, 2013

Related U.S. Application Data
(60) Provisional application No. 61/478,008, filed on Apr. 21, 2011.

(51) Int. Cl. H04L 29/06

(52) U.S. Cl. CPC H04L 67/42
USPC 709/203

(57) ABSTRACT

Methods and devices configured to provide a key-free, one-way coding of sensitive data such that efficient parallel scaling methods may be used to perform computations related to the sensitive initial data without risking unwanted disclosure of the sensitive initial data are provided. In some embodiments, a set of intermediate representations of the initial data set is calculated using a one-way computation. The set of intermediate representations is then sent to a server computing system for calculating results in a scalable manner. The initial data is secured from unwanted access at the server computing system at least because the one-way computation does not allow the initial data to be derived from the intermediate representations.

### CROSS-REFERENCE TO RELATED APPLICATION

This application claims the benefit of U.S. Provisional Application No. 61/478008, filed Apr. 21, 2011, the entire disclosure of which is incorporated herein by reference for all purposes.

### BACKGROUND

While computing devices are becoming more powerful and capable of executing more and more instructions in a given time period, certain classes of computations remain difficult for a single computing device to complete in a reasonable amount of time. Some such computations may be implemented using scalable software, in which the computations may be performed in parallel by a collection of server computing devices, such as a parallel computing cluster; a “cloud computing” system such as Amazon EC2; a distributed computing system such as distributed.net, and/or the like.

Such computations may arise in a variety of engineering and computing fields, including, but not limited to, electronic design automation, multiphysics design, financial portfolio optimization, information retrieval (such as internet search and/or the like), recommendation engines, bioinformatics, and computational drug design. Many such computations are associated with sensitive initial data, such as design information of a molecule, a chip layout, a financial portfolio, user information, and/or the like that is important to protect from public disclosure. Unfortunately, many of the most useful server computing devices available for such computations are provided by third parties, are potentially accessible to the public, or are otherwise outside of the control of an individual requesting the computation. There is a concern that transmitting the critical data to the server computing devices to perform the computations may result in unwanted disclosure of the sensitive initial data.

In some existing technologies, strong encryption of the sensitive initial data is applied before transmission to the server computing device, and the encrypted data is decrypted by the server computing device before further processing is performed. While these technologies are effective in protecting the sensitive initial data while in transit to the server computing device, such protection is only as secure as a key used for encryption. Also, once the sensitive initial data is decrypted by the server computing device, anyone who obtains access to the server computing device may be able to access the sensitive initial data directly. What is needed is a way to enable the use of server computing devices for performing computations wherein there is no risk of disclosure of sensitive initial data, both while in transit to the server computing device and on the server computing device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system for performing computations relating to an initial data set is provided. The system comprises a local computing device and a server computing system. The server computing system includes one or more server computing devices. The local computing device is configured to perform a one-way computation to generate one or more intermediate representations of the initial data set; transmit the one or more intermediate representations to the server computing system; receive one or more partial results corresponding to the one or more intermediate representations from the server computing system; and store the one or more partial results in a result data store.

In some embodiments, a computer-implemented method of preventing disclosure of data processed by a server computing system is provided. The method comprises performing a one-way computation to generate one or more intermediate representations of an initial data set; transmitting the one or more intermediate representations to the server computing system; receiving one or more partial results from the server computing system; combining the one or more partial results into a final result; and providing the final result for presentation to a user.

In some embodiments, a computer-implemented method of determining results for an initial data set without having access to the initial data set is provided. The method comprises receiving, from a requesting computing device, one or more intermediate representations based on the initial data set, wherein the initial data set is not determinable from the one or more intermediate representations; determining one or more partial results based on the one or more intermediate representations; and transmitting the one or more partial results to the requesting computing device.

In some embodiments, a computing device configured to perform one of the above disclosed methods is provided. Also, in some embodiments, a computer-readable storage medium having computer-executable instructions stored thereon is provided. In response to execution by one or more processors of a computing device, the instructions cause the computing device to perform actions associated with any of the methods disclosed herein.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1B illustrate, in general, an example of a mathematical process that may be computed within embodiments of the present disclosure;

FIG. 2 is a schematic diagram that illustrates, at a high level, a problem with existing attempts to secure initial data sets for processing by a server computing system;

FIG. 3 is a schematic diagram that illustrates an exemplary embodiment of a system for protecting an initial data set for processing by a server computing system according to various aspects of the present disclosure;

FIG. 4 is a block diagram that illustrates an exemplary embodiment of a local computing device and a server computing system according to various aspects of the present disclosure;

FIG. 5 is a flowchart that illustrates an exemplary embodiment of a method of secure remote computation according to various aspects of the present disclosure; and

FIG. 6 is a block diagram that illustrates aspects of an exemplary computing device appropriate for use with embodiments of the present disclosure.

### DETAILED DESCRIPTION

Embodiments of the present disclosure utilize a key-free, one-way coding of sensitive initial data, such that efficient parallel scaling methods may be used to perform computations related to the sensitive initial data without risking unwanted disclosure of the sensitive initial data. Some embodiments of the present disclosure use a compressible matrix representation of the initial data as an intermediate towards a final solution, and may be used for any problem class for which such a representation may be generated. The compressible matrix representations, and not the initial data, are made available to the server computing devices for processing.

Embodiments of the present disclosure may have any of a variety of benefits. For example, one possible benefit of embodiments of the present disclosure is that the disclosed technique does not use keys to protect the initial data. As no encryption keys are used, there are no worries relating to maintaining the security of such keys to maintain the security of the initial data. Another example of a benefit provided by some embodiments of the present disclosure is the lack of availability of the initial data at the server computing device. The intermediate representation is a one-way encoding of the initial data, in that there is no computational or mathematical method to uniquely determine the initial data that generated a given intermediate representation. Hence, providing the intermediate representation to the server computing device does not risk disclosure of the initial data. Other examples of benefits provided by some embodiments of the present disclosure are scalability and efficiency. Some problems solvable with embodiments of the present disclosure use intermediate representations that are normally computed for scalable solutions, the encoding actually assists in providing scalability and does not cause an additional bottleneck and does not require additional processing.

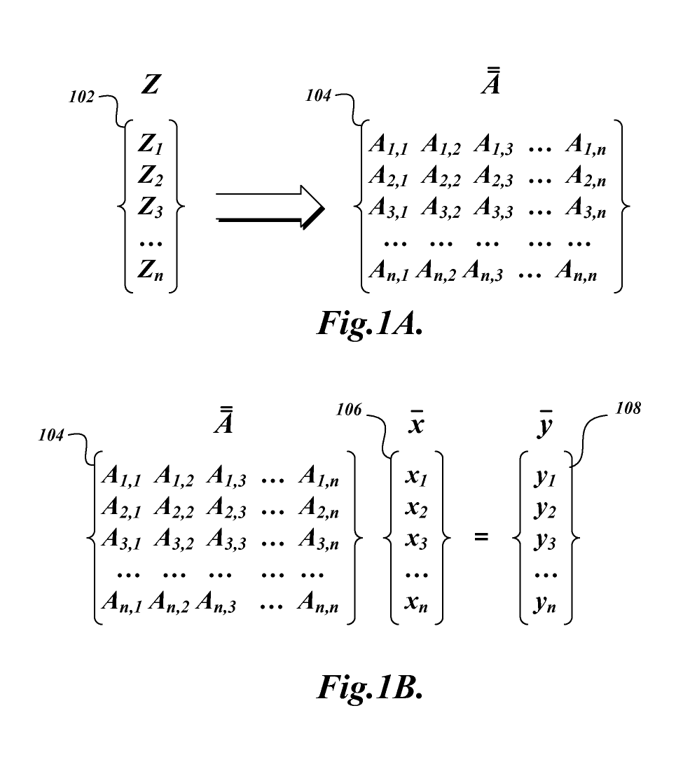

FIGS. 1A-1B illustrate, in general, an example of a mathematical process that may be computed within embodiments of the present disclosure. In FIG. 1A, an initial data set 102, is represented as a vector Z having n elements. The initial data set 102 represents the data to be analyzed, such as information defining a molecular structure; a time series of price information for one or more stocks, bonds, securities, currencies, or other commodities; a shape of a component; and/or the like. A pre-defined transformation may be used to generate a system matrix 104, represented by the matrix A̅ which has n×n elements. Though the illustrated initial data set 102 does not appear to be large, in some embodiments n may be on the order of 10⁶ or greater, meaning that the system matrix 104 may have 10¹² elements or more.

In FIG. 1B, the system matrix 104 multiplied by a performance vector 106 is made equivalent to a set of known values 108. The performance vector 106 is represented as a vector x̅, and the set of known values 108 is represented as a vector y̅. The performance vector 106 is then determined, which represents a solution for the initial data set 102. To determine the performance vector 106, a technique such as an iterative solver may be used. For example, given the equation Ax=y (a simplified form of the equation described in FIG. 1B), x may be determined by determining an initial value x₀, and then comparing Ax₀ to y. A value x₁ may be computed based on Ax₀-y. This process may then be repeated m times to compute successively more accurate values for x. As computation of each iteration is computationally expensive, benefits in scalability can be achieved by performing such computations on a server computing system such as a cloud computing system and/or the like. Some examples of topics having problems that may be stated and solved in this fashion include determining molecular simulation for, for example, drug design; microfluidics; scoring results for information retrieval; optimization of financial portfolios, and the like. These examples are nonlimiting, and embodiments of the present disclosure may be used to process any dense matrix solution problem that exhibits smoothness properties in sections of the matrix.

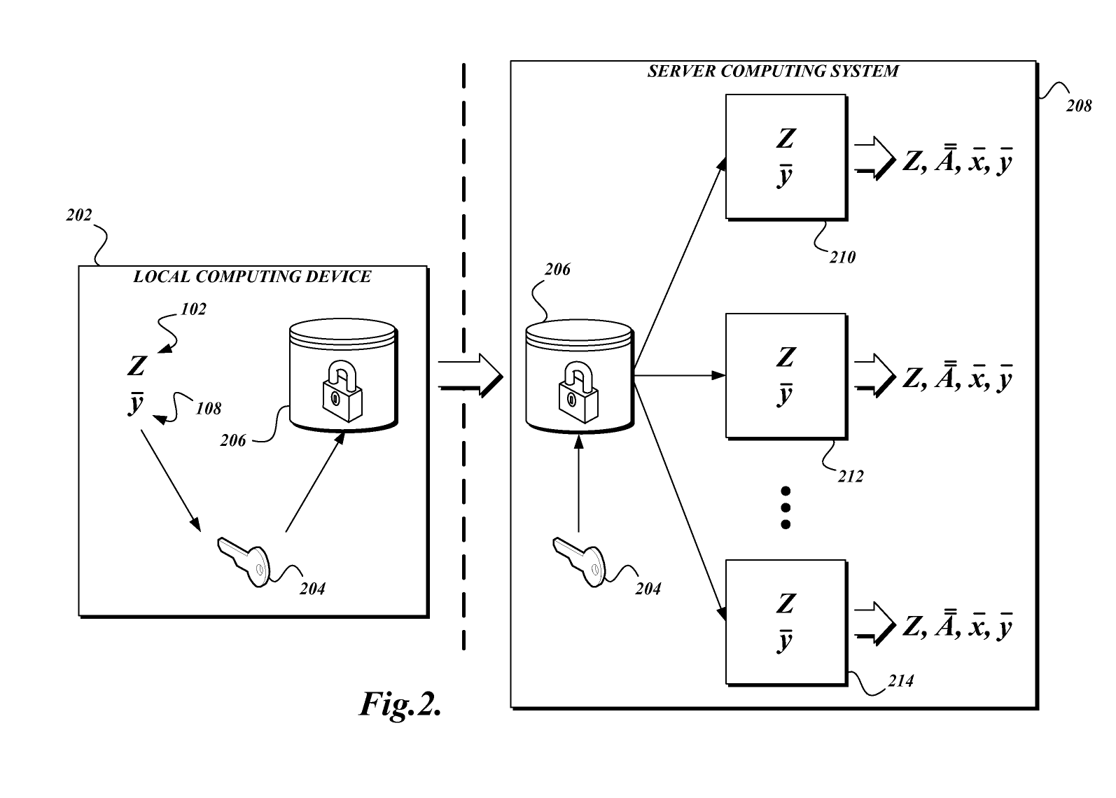

FIG. 2 is a schematic diagram that illustrates, at a high level, a problem with existing attempts to secure initial data sets for processing by a server computing system. A local computing device 202 has an initial data set 102 and a set of known values 108. The local computing device 202 encrypts the initial data set 102 and the set of known values 108 using an encryption key 204 to create an encrypted data set 206. The encrypted data set 206 is transmitted to a server computing system 208. At this point, the initial data set 102 is protected from unauthorized access by virtue of being within the encrypted data set 206. However, computations may not be performed on the initial data set 102 in the encrypted state. Hence, the encryption key 204 is obtained by the server computing system 208 to decrypt the encrypted data set 206 and obtain the initial data set 102 and the set of known values 108. The initial data set 102 (or portions thereof) and the set of known values 108 (or portions thereof) are then distributed to a set of computing nodes 210, 212, 214 to compute solutions for the initial data set 102. Illustrated to the right of the set of computing nodes 210, 212, 214 is a list of the information available to each of the set of computing nodes 210, 212, 214. As can be seen, each computing node 210, 212, 214 not only has access to the known values 108, the performance vector 106, and the system matrix 104 (or portions thereof), but also to the initial data set 102 (or a portion thereof). If an unauthorized party obtains access to a computing node 210, 212, 214, the secrecy of the initial data set 102 may be compromised.

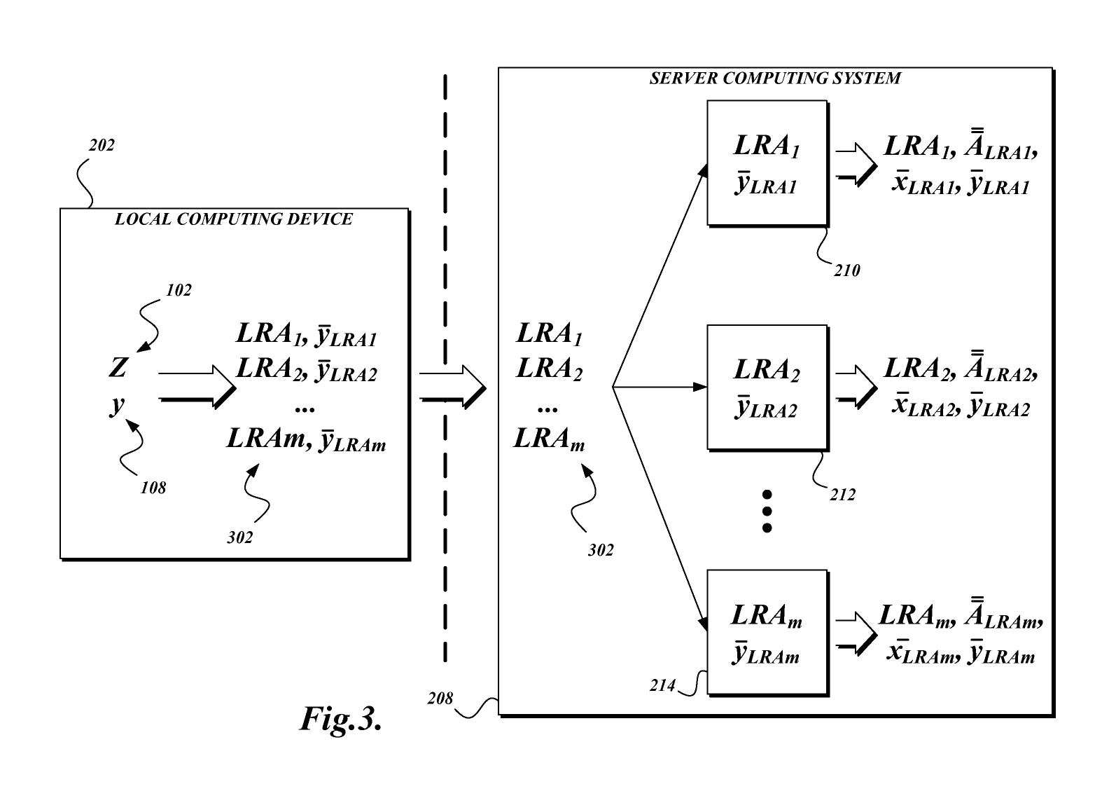

FIG. 3 is a schematic diagram that illustrates an exemplary embodiment of a system for protecting an initial data set 102 for processing by a server computing system 208 according to various aspects of the present disclosure. The local computing device 202 uses the initial data set 102 to calculate a set of intermediate representations. The intermediate representation is a compressible matrix representation of the system matrix 104 that arises as an intermediate towards the final solution. The creation of the intermediate representations does not require a key. Further, the creation of the intermediate representations is not reversible. That is, given an intermediate representation, it is not possible to uniquely determine the initial data set 102. As the matrix problem illustrated in FIGS. 1A-1B was described as relating to a dense smooth matrix, the system matrix 104 may be represented as a superposition of low-rank approximations. Accordingly, one example of a set of intermediate representations is a set of low-rank approximations 302, as illustrated in FIG. 3. In some embodiments, the set of low-rank approximations 302 may be generated via Green's functions, or using any other suitable technique.

The low-rank approximations 302 may each be used to calculate the performance vector 106 (or at least a portion thereof). Hence, the set of low-rank approximations 302 is transmitted to the server computing system 208, which distributes the set of low-rank approximations 302 among the set of computing nodes 210, 212, 214 for computation. In some embodiments, the set of known values 108 or portions of the set of known values 108 corresponding to each of the set of low-rank approximations 302 may be distributed along with the set of low-rank approximations 302. Again, a list of information available to each computing node is illustrated to the right of each computing node 210, 212, 214. As shown, each of the computing nodes has access to, at most, a low-rank approximation, a portion of the system matrix 104, a portion of the performance vector 106, and a portion of the known values 108. Importantly, none of the computing nodes 210, 212, 214 have access to any portion of the initial data set 102, nor can any of the computing nodes 210, 212, 214 determine any portion of the initial data set 102 from the information they have received. Thus, the initial data set 102 remains protected.

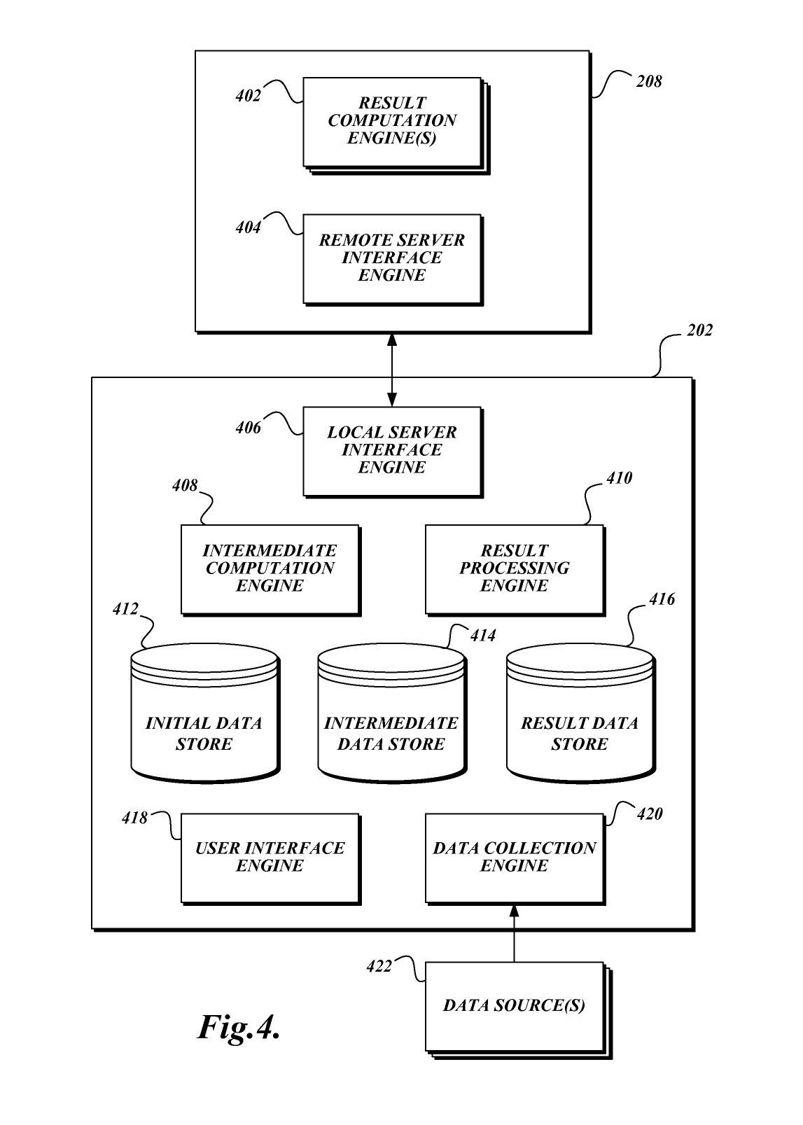

FIG. 4 is a block diagram that illustrates an exemplary embodiment of a local computing device 202 and a server computing system 208 according to various aspects of the present disclosure. One distinction between the local computing device 202 and the server computing system 208 is that the local computing device 202 has access to an initial data set 102, while the server computing system 208 performs computations without having access to the initial data set 102. Actual physical locations of the local computing device 202 and the server computing system 208 are not necessarily important, but are described herein in terms of a “local” device and a “server” system for ease of discussion. The local computing device 202 may be any suitable computing device configured to provide the functionality described herein, such as a desktop computing device, a laptop computing device, a tablet computing device, a smart phone, and/or the like. In some embodiments, what is illustrated in FIG. 4 as a single computing device that makes up the local computing device 202 could include multiple computing devices. For example, in some embodiments, the local computing device 202 may include a trusted cluster computing device or other parallel processing system that is trusted to be provided access to the initial data set 102 and to execute one or more of the engines illustrated in association with the local computing device 202. The server computing system 208 may include one or more suitable computing devices, such as server computing devices, desktop computing devices, virtualized computing instances or application objects executing on a server computing device, and/or the like, configured to provide the functionality described herein.

As illustrated, functionality of the local computing device 202 and the server computing system 208 may be provided by one or more engines. In general, one of ordinary skill in the art will recognize that an “engine” may be logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines, can be duplicated to provide greater processing capability, or can be divided into sub-engines. The engines can be stored in any type of computer-readable medium or computer storage device and be stored on and executed by one or more processors of a general purpose computing device, thus creating a special purpose computing device configured to provide the engine and/or the functionality thereof.

In the illustrated embodiment, the local computing device 202 includes a local server interface engine 406, an intermediate computation engine 408, a result processing engine 410, a user interface engine 418, and a data collection engine 420.

The local server interface engine 406 is configured to transmit information from the local computing device 202 to the server computing system 208, to instruct the server computing system 208 to process the information, and to receive results from the server computing system 208. In some embodiments, the local server interface engine 406 may be configured to communicate with an application programming interface (API) provided by the server computing system 208. In some embodiments, the local server interface engine 406 may be configurable to communicate with different APIs or server computing systems 208. In some embodiments, a local server interface engine 406 customized for a particular API or server computing system 208 may be swapped out for a different local server interface engine 406 if use of a different server computing system 208 is desired.

The user interface engine 418 is configured to receive commands from a user and to present results to the user. In some embodiments, the user interface engine 418 may be configured to receive an initial data set 102, a specification of an initial data set 102, or instructions for collecting an initial data set 102 from the user. In some embodiments, the user interface engine 418 may be configured to generate and present a graphical user interface to the user via a display device. In some embodiments, the user interface engine 418 may be configured to present results to the user via another suitable technique, such as via a loudspeaker, a printer, and/or the like.

The data collection engine 420 is configured to collect an initial data set 102 based on instructions received from the user interface engine 418. In some embodiments, the data collection engine 420 may be configured to collect data from one or more data sources 422 in a raw format, and to refactor the data into a format usable by other portions of the local computing device 202 before storing the refactored data in the initial data store 412. The data sources 422 may include any suitable data source. In some embodiments, a data source 422 may be a data store that includes data generated by another system. For example, the data source 422 may be a data store that includes historical price information for securities such as stocks, bonds, currencies, and/or the like, or a set of web pages along with data representing interconnections among the web pages. Another example of a data source 422 may be a sensor configured to detect a physical state such as temperature at a location of an integrated circuit. Another example of a data source 422 may be a file storing a model of a molecule, a chip layout, and/or another type of information describing a physical structure to be analyzed. Any of these data sources 422 may be queried by the data collection engine 420 to generate the initial data set 102.

The intermediate computation engine 408 is configured to perform one-way computations on the initial data set 102 to generate intermediate representations of the initial data set 102 to be transmitted to the server computing system 208. In some embodiments, the intermediate computation engine 408 is also configured to scramble or otherwise obfuscate the intermediate representations, and to store the intermediate representations along with information for unscrambling or de-obfuscating the intermediate representations in an intermediate data store 414. Further description of these computations is provided below.

The result processing engine 410 is configured to receive results computed by the server computing system 208 and to store compiled results in the result data store 416. In embodiments wherein the intermediate computation engine 408 is configured to obfuscate the intermediate representations, the result processing engine 410 may be configured to unscramble or de-obfuscate the results based on the information stored in the intermediate data store 414. Further discussion of the actions of the result processing engine 410 are provided further below.

In the illustrated embodiment, the local computing device 202 also includes an initial data store 412, an intermediate data store 414, and a result data store 416, which are configured to store at least initial data sets, intermediate representations, and results, respectively, as well as further information described elsewhere herein. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network. A data store may also include data stored in an organized manner on a storage medium 608, as described further below. One of ordinary skill in the art will recognize that separate data stores described herein may be combined into a single data store, and/or a single data store described herein may be separated into multiple data stores, without departing from the scope of the present disclosure.

In the illustrated embodiment, the server computing system 208 includes one or more computing devices configured to provide a remote server interface engine 404 and one or more result computation engines 402. The remote server interface engine 404 is configured to receive intermediate representations from the local computing device 202 and to distribute them among the result computation engines 402 for processing. In some embodiments, the remote server interface engine 404 may also be configured to receive results from the result computation engines 402 and to transmit them to the local computing device 202. The result computation engines 402 compute results based on the intermediate representations, as discussed further below. In some embodiments, the result computation engines 402 may be software objects or servers in a cloud computing system, such as Amazon Elastic Compute Cloud (EC2), Microsoft Windows Azure Platform, Google App Engine, and/or the like. In some embodiments, the functionality of the remote server interface engine 404 may be provided by a separate server computing device from the result computation engines 402. In some embodiments, the functionality of the remote server interface engine 404 may be included in one of the result computation engines 402. In some embodiments, the functionality of the remote server interface engine 404 may be included in the local computing device 202, which may then transmit intermediate representations directly to the result computation engines 402.

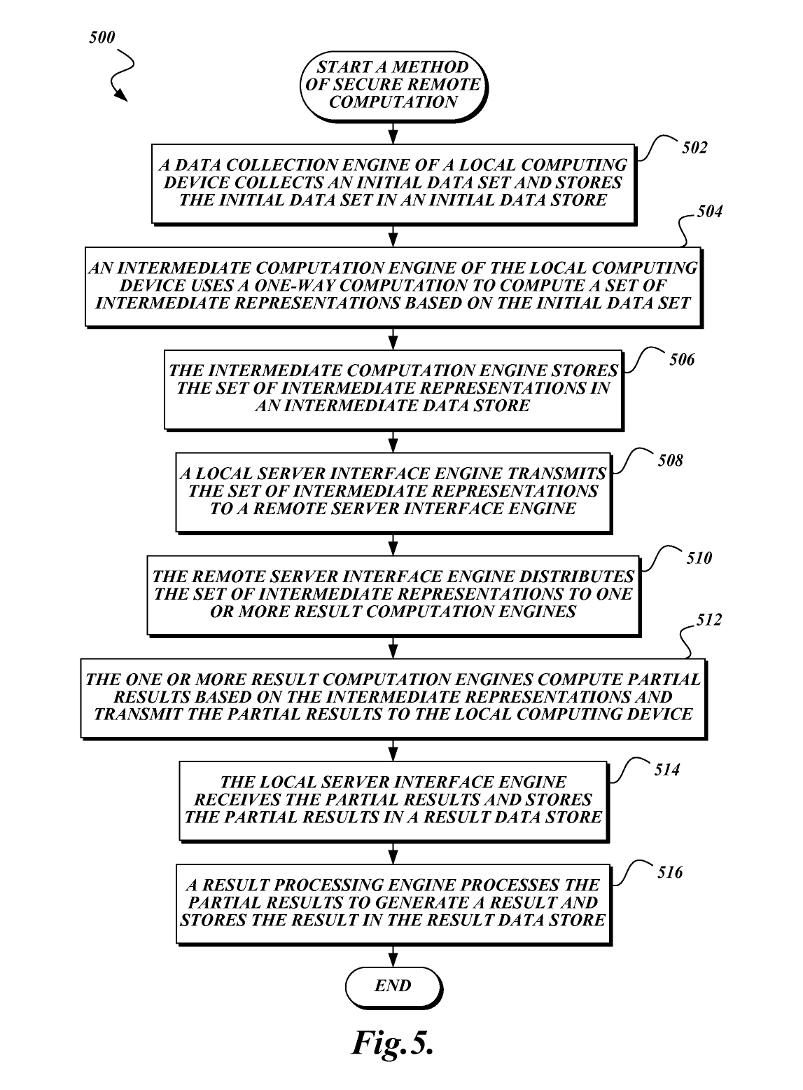

FIG. 5 is a flowchart that illustrates an exemplary embodiment of a method 500 of secure remote computation according to various aspects of the present disclosure. From a start block, the method 500 proceeds to block 502, where a data collection engine 420 of a local computing device 202 collects an initial data set and stores the initial data set in an initial data store 412. As discussed above, the initial data set may represent any suitable type of information that poses a dense matrix problem that has smoothness properties in sections of the matrix, including but not limited to historical price information for stocks or other securities, molecular geometry or composition information, material properties, and/or any other type of information with a definable interaction between data elements. As discussed above, the initial data set may be collected by the data collection engine 420 from one or more data sources 422. Also, as the initial data set may include sensitive information to be protected from unwanted disclosure, steps may be taken to ensure that the initial data store 412 is protected from unauthorized access. The data collection engine 420 may also collect and store a set of known values 108.

Next, at block 504, an intermediate computation engine 408 of the local computing device 202 uses a one-way computation to compute a set of intermediate representations based on the initial data set. In some embodiments, the intermediate representations may represent a step towards computing a final answer, and so computing the intermediate representations does not require additional computational overhead. The intermediate representation should be computable from the initial data set in a reasonable time so that it may be computed by the local computing device 202 without sending the initial data set to an untrusted computing device. One example of an intermediate representation is a low-rank approximation of the system matrix 104. Each low-rank approximation may be a compressible, scalable, low-rank multilevel matrix representation of the system matrix 104. “Low-rank” refers to the characteristic that the approximation has fewer rows and/or columns than the complete system matrix 104, and in some embodiments, each low-rank approximation represents a particular range of rows and columns of the system matrix 104. In some embodiments, the low-rank approximations may be generated by a Green's function executed on at least a portion of the initial data set, though in other embodiments, other techniques may be used.

At block 506, the intermediate computation engine 408 stores the set of intermediate representations in an intermediate data store 506. In some embodiments, the intermediate computation engine 408 may transmit the set of intermediate representations directly to the server computing system 208 without first storing the set of intermediate representations in the intermediate data store 414. In some embodiments, the intermediate computation engine 408 may also generate and store portions of the set of known values 108 that correspond to the set of intermediate representations. In some embodiments, the intermediate computation engine 408 may obfuscate the intermediate representations before transmitting them to the server computing system 208. For example, if the intermediate representations are low-rank approximations of the system matrix 104 each representing a set of rows and a set of columns of the system matrix 104, then the intermediate computation engine 408 may reorder the rows and/or columns of the intermediate representations, or may otherwise indicate to the server computing system 208 that each low-rank approximation represents a different portion of the system matrix 104 than it actually represents. The intermediate computation engine 408 may then store a mapping of the reordered rows and/or columns for each intermediate representation in the intermediate data store 414 that will allow results for each intermediate representation to be mapped back to the correct portions of the system matrix 104. In such an embodiment, the overall solution for the system matrix 104 may also be hidden from the server computing system 208 to provide an extra layer of security.

At block 508, a local server interface engine 406 transmits the set of intermediate representations to a remote server interface engine 404. As stated above, the set of intermediate representations may be the set of intermediate representations generated by the intermediate computation engine 408 without obfuscation (in which case the initial data set will be hidden from the server computing system 208) or with obfuscation (in which case both the initial data set and the overall solution will be hidden from the server computing system 208). In some embodiments, additional information for computing the results, such as the known values 108 or a subset thereof, may also be transmitted to the remote server interface engine 404. In some embodiments, the local server interface engine 406 may encrypt the set of intermediate representations before transmission to the remote server interface engine 404 to provide an additional layer of security.

At block 510, the remote server interface engine 404 distributes the set of intermediate representations to one or more result computation engines 402. As discussed above, the one or more result computation engines 402 may each be provided by separate computing devices, multiple computation engines 402 may be provided by a single computing device, and/or the like. In some embodiments, a large number of result computation engines 402, either located in a single data center or distributed in multiple data centers or other locations across a wide area network such as the Internet, may be used. In some embodiments, any other suitable parallel distributed computing technique or system may be used to provide the result computation engines 402. In some embodiments, the remote server interface engine 404 may decrypt the set of intermediate representations, if they were encrypted by the local server interface engine 406. In some embodiments, the remote server interface engine 404 may distribute the known values 108 or subsets thereof along with the set of intermediate representations.

At block 512, the one or more result computation engines 402 compute partial results based on the intermediate representations and transmit the partial results to the local computing device 202. The computation of partial results may use any suitable technique for the problem being solved. In some embodiments, the computations may include performing iterative calculations such as Krylov-subspace iterations, iterated reweighting to alter covariance values, and/or the like. In some embodiments, the iterative calculations may be performed over the reordered matrix-vector products calculated by the intermediate computation engine 408 to obfuscate the intermediate representations. In some embodiments, the computations may include performing factorization on the intermediate representations, or any other suitable calculation. In some embodiments, the partial results may be transmitted by the result computation engines 402 to the remote server interface engine 404 for transmission to the local computing device 202. In some embodiments, the result computation engines 402 may transmit the results directly to the local computing device 202 without using the remote server interface engine 404.

At block 514, the local server interface engine 406 receives the partial results and stores the partial results in a result data store 416. In some embodiments, the local server interface engine 406 may not handle the partial results, but instead the partial results would be transmitted directly to the result processing engine 410 or the result data store 416. At block 516, the result processing engine 410 processes the partial results to generate a result and stores the result in the result data store 416. In some embodiments, if the intermediate representations were obfuscated before transmission to the server computing system 208, the result processing engine 410 may use the information stored in the intermediate data store 414 to de-obfuscate the partial results. For example, if the row and/or column information for an intermediate representation was changed to an obfuscated value, the correct value would be restored for the corresponding partial result by the result processing engine 410 based on the information stored in the intermediate data store 414. In some embodiments, the user interface engine 418 may be configured to further analyze the result and to present the result and/or the further analysis thereof to the user via a display device, a printer, and/or by any other suitable means. The method 500 then proceeds to an end block and terminates.

Though exemplary calculations and applications are discussed above, one of ordinary skill in the art will understand that these examples should not be seen as limiting. Embodiments of the present disclosure may be useful for any calculation performed by an untrusted remote server on a sensitive initial data set, wherein the calculation includes an intermediate representation precursor from which the initial data set is not determinable.

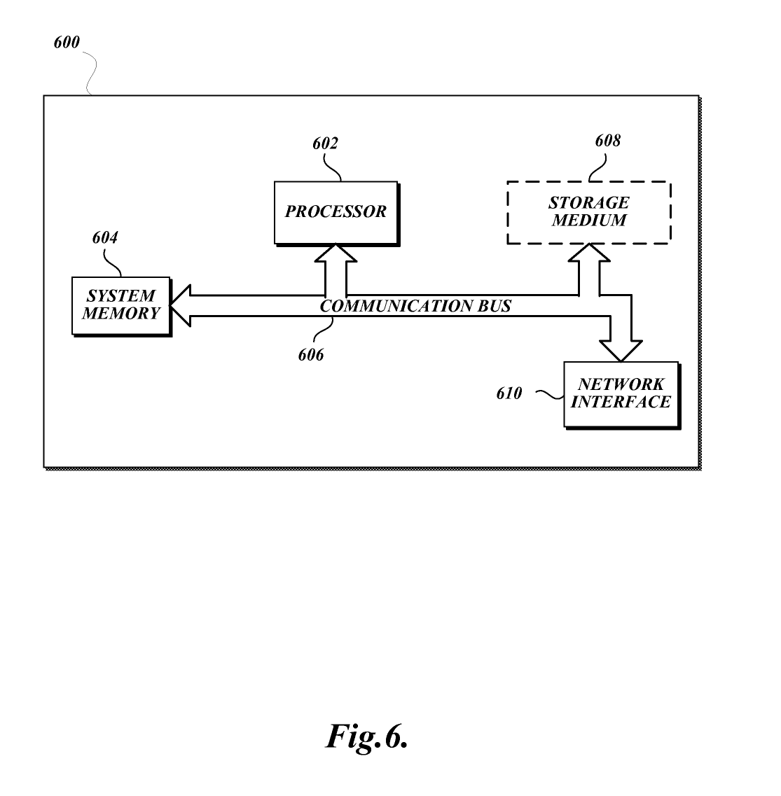

FIG. 6 is a block diagram that illustrates aspects of an exemplary computing device 600 appropriate for use with embodiments of the present disclosure. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, LTE, WiMAX, Bluetooth, and/or the like.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, USB, or other suitable connections protocols using wireless or physical connections. Similarly, the computing device 600 may also include output devices such as a display, speakers, printer, etc. Since these devices are well known in the art, they are not illustrated or described further herein.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted Likewise, unless explicitly stated, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A system for performing computations relating to an initial data set, the system comprising:
a local computing device; and
a server computing system including one or more server computing devices;
wherein the local computing device is configured to:
perform a one-way computation to generate one or more intermediate representations of the initial data set;
transmit the one or more intermediate representations to the server computing system;
receive one or more partial results corresponding to the one or more intermediate representations from the server computing system; and
store the one or more partial results in a result data store.

2. The system of claim 1, wherein performing the one-way computation to generate one or more intermediate representations of the initial data set includes computing one or more low-rank approximations of the initial data set.

3. The system of claim 2, wherein the one or more low-rank approximations include one or more compressible, scalable, low-rank multilevel matrix representations.

4. The system of claim 2, wherein computing one or more low-rank approximations of the initial data set includes computing a Green's function over the initial data set to generate the one or more low-rank approximations.

5. The system of claim 1, wherein the one or more server computing devices are configured to:
receive one or more intermediate representations;
compute one or more partial results based on the one or more intermediate representations; and
transmit the one or more partial results to the local computing device.

6. The system of claim 5, wherein computing one or more partial results based on the one or more intermediate representations includes performing scalable matrix operations and calculating matrix-vector products based on the one or more intermediate representations.

7. The system of claim 5, wherein computing one or more partial results based on the one or more intermediate representations includes at least one computation selected from a set consisting of:
performing Krylov-subspace iterations with reordered matrix-vector products;
performing iterated re-weighting to alter covariance values;
performing factorization; and
performing iterative calculations.

8. The system of claim 1, wherein the local computing device is further configured to obfuscate the one or more intermediate representations after generation.

9. The system of claim 8, wherein obfuscating the one or more intermediate representations includes randomly reordering rows or columns of the one or more intermediate representations.

10. The system of claim 8, wherein the local computing device is further configured to process the partial results received from the server computing system based on the obfuscation of the one or more intermediate representations in order to de-obfuscate the partial results.

11. The system of claim 8, wherein obfuscating the one or more intermediate representations includes encrypting the one or more intermediate representations for decryption by the server computing system.

12. The system of claim 8, wherein the local computing device is further configured to store information in an intermediate data store for reversing the obfuscation of the one or more intermediate representations.

13. The system of claim 1, wherein the local computing device is further configured to collect the initial data set.

14. The system of claim 13, further comprising one or more sensors configured to detect a physical state, and wherein collecting the initial data set includes receiving a set of data from the one or more sensors.

15. The system of claim 13, wherein collecting the initial data set includes one or more actions selected from the group consisting of:
receiving price history information;
receiving information describing a chemical compound;
receiving information describing a structure of a physical object; and
receiving information for generating information retrieval result rankings

16. The system of claim 1, wherein the local computing device is further configured to:
combine the one or more partial results into a final result associated with the initial data set; and
provide the final result for presentation to a user.

17. A computer-implemented method of preventing disclosure of data processed by a server computing system, the method comprising:
performing a one-way computation to generate one or more intermediate representations of an initial data set;
transmitting the one or more intermediate representations to the server computing system;
receiving one or more partial results from the server computing system;
combining the one or more partial results into a final result; and
providing the final result for presentation to a user.

18. The method of claim 17, wherein performing the one-way computation includes computing one or more low-rank approximations of the initial data set.

19. The method of claim 18, wherein the one or more low-rank approximations include one or more compressible, scalable, low-rank multilevel matrix representations.

20. The method of claim 18, wherein computing one or more low-rank approximations of the initial data set includes computing a Green's function over the initial data set to generate the one or more low-rank approximations.

21. The method of claim 17, further comprising obfuscating the one or more intermediate representations by reversibly encrypting the one or more intermediate representations or by reversibly reordering rows or columns of the one or more intermediate representations.

22. The method of claim 21, wherein combining the one or more partial results into a final result includes processing the one or more partial results based on the obfuscation of the one or more intermediate representations.

23. The method of claim 17, further comprising collecting the initial data set.

24. The method of claim 23, wherein collecting the initial data set includes receiving a set of data from one or more sensors configured to detect a physical state.

25. The method of claim 23, wherein collecting the initial data set includes one or more actions selected from the group consisting of:
receiving price history information; receiving information describing a chemical compound;
receiving information describing a structure of a physical object; and
receiving information for generating information retrieval result rankings

26. The method of claim 17, further comprising storing the partial results or the final result in a result data store.

27. A computer-implemented method of determining results for an initial data set without having access to the initial data set, the method comprising:
receiving, from a requesting computing device, one or more intermediate representations based on the initial data set, wherein the initial data set is not determinable from the one or more intermediate representations;
determining one or more partial results based on the one or more intermediate representations; and
transmitting the one or more partial results to the requesting computing device.

28. The method of claim 27, wherein determining one or more partial results based on the one or more intermediate representations includes performing scalable matrix operations and calculating matrix-vector products based on the one or more intermediate representations.

29. The method of claim 27, wherein determining one or more partial results based on the one or more intermediate representations includes performing at least one computation selected from a set consisting of:
performing Krylov-subspace iterations with reordered matrix-vector products;
performing iterated re-weighting to alter covariance values; performing factorization; and
performing iterative calculations.

30-31. (canceled)
